(19) United States
(12) Patent Application Publication
(10) Pub. No.: US 2002/0075458 A1
(43) Pub. Date: Jun. 20, 2002

(54) Method for correcting spherical aberration of a projection lens in an exposure system

(75) Inventor: Seiji Matsuura, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC CORPORATION

(21) Appl. No.: 10/013,481

(22) Filed: Dec. 13, 2001

(30) Foreign Application Priority Data
Dec. 18, 2000 (JP) 2000-383166

(51) Int. Cl. G03B 21/00

(52) U.S. Cl. 353/69

(57) ABSTRACT

A method for correcting a spherical aberration of a projection lens in an exposure system includes the step of measuring a best focus shift amount by using an exposure light passed by a half-tone phase shift mask having a specific configuration, and correcting the spherical aberration of the projection lens based on the best focus shift amount measured. The half-tone phase shift mask has therein an array of square hole patterns arranged at a pitch P and each having a pattern size of M, P and M satisfying the following relationships:

0.8λ/(2×NA)≦M≦1.2λ/(2×NA);

{λ/(P×NA)}+σ≦1; and

{2×λ/(P×NA)}−σ≧1,

wherein λ, σ and NA are wavelength and coherence factor of the exposure light and numerical aperture of the projection lens, respectively.

### BACKGROUND OF THE INVENTION

(a) Field of the Invention

The present invention relates to a method for correcting the spherical aberration of a projection lens in an exposure system and, more particularly, to a method for correcting the spherical aberration based on the best focus shift amount.

(b) Description of the Related Art

In a fabrication process for semiconductor devices, the pattern of the semiconductor devices is generally obtained by using a photolithographic technique to form an etching mask on a subject film to be patterned.

More specifically, a photoresist film is first formed on a subject film to be patterned, such as an interconnect layer or an insulation layer, followed by patterning the photoresist film by an exposure system using the photolithographic technique to form the etching mask. The underlying subject film is then patterned by an etching technique, such as a plasma-enhanced etching technique, using the etching mask. Examples of the exposure system used therein include a demagnification projection exposure system, which may be referred to as simply exposure system hereinafter, wherein a reticle pattern is transferred onto the photoresist film while reducing the pattern size on the photoresist film by using a projection lens optical system.

It has ever been desired to reduce the dimensions of the semiconductor elements and to increase the degree of integration thereof in the semiconductor devices. For responding to such a demand, the design rule of the pattern is reduced by increasing the numerical aperture (NA) of the projection lens in the exposure system to reduce the critical resolution thereof. This is employed in consideration of the known relationship between the numerical aperture and the critical resolution (R) of the projection lens, known as Rayleigh formula:

R=K1×λ/NA,

wherein λ is the wavelength of the exposure light.

However, it is also known that a higher numerical aperture of the projection lens narrows the focus depth, and accordingly, only a miner deviation or shift of the focal point causes a defect, although the higher numerical aperture improves the resolution as described above. This highlights the importance of the reduction in the spherical aberration of the projection lens in view of enlarging the focus depth, the spherical aberration causing the difference in the focal point.

The spherical aberration as mentioned above raises a problem especially in the exposure system using a phase shift mask. This results from the fact that, although the correction of the projection lens is performed during introduction of a new exposure system under the standard conditions of the numerical aperture and the coherence factor (σ) of the exposure light, the optical paths of the exposure light passing the phase shift mask change on the pupil surface of the projection lens due to the differences in the numerical aperture and the coherence factor between the conditions of the practical fabrication process and the standard conditions. The change of the optical paths causes the spherical aberration.

Referring to FIG. 1, there is shown the reason for the occurrence of the spherical aberration. Diffracted lights, or the components 21, 22 and 23 of the diffracted light, diffracted by the phase shift mask (not shown), pass the pupil surface of the projection lens 20 at different positions, and form a focus on the surface of the photoresist film, which is shown as the original best focus surface 34. Due to the spherical aberration of the project lens 20, the actual focal point (or best focus) shifts from the original best focal point. The amount of the focus shift (FS) is referred to as “focus shift amount” hereinafter. The aberration causes the equi-phase plane 24 to be an ununiform plane, which may be otherwise a flat plane.

As illustrated in FIG. 1, the spherical aberration occurs due to the difference between the optical paths of the diffracted lights 21, 22 and 23 passed by the phase shift mask, wherein the difference between the optical paths depend on the distances between the optical paths on the pupil surface of the projection lens 20 and the center of the pupil surface. The aberration causes the variance or scattering of dimensions in an isolated pattern formed on the surface of the photoresist film. Under the circumstance of the presence of such a spherical aberration, the diffracted lights, i.e., respective-order components 21, 22 and 23 of the diffracted light have a phase difference therebetween to degrade the imagery performance of the projection lens 20. Thus, for achieving a higher accuracy of the patterning, it is essential to reduce the spherical aberration of the project lens.

In a conventional technique by which the correction of the spherical aberration is performed in the exposure system (on-body exposure system) carrying thereon a projection lens involving therein the spherical aberration, it is usual to use a difference in the best focus shift amount between a plurality of hole patterns having different sizes, as an index of the spherical difference. The difference is caused by the diffracted lights each passing the different positions on the pupil surface depending on the pattern sizes, as described above. The term “best focus shift amount” as used herein means a distance between the original best focal point and an actual focal point at which the best focus is obtained depending on the spherical aberration.

For example, Patent Publication JP-A-2000-266640 describes a technique for measuring the spherical aberration caused by the projection lens, wherein a pair of reticles having two-dimensional periodic patterns (diced patterns) satisfying respective specific conditions are used in an exposure system for estimating the respective spherical aberrations. In this technique, the relationships between the different focal points and the flatness factors of the transferred patterns corresponding to the respective focal points are measured to quantitatively evaluate the spherical aberration of the projection lens.

Patent Publication JP-B-3080024 describes a technique for estimating a spherical aberration, wherein a plurality of phase shift masks having different phase shift amounts therebetween and each having an isolated pattern is used for exposure in an exposure system. By specifying one of the phase shift masks having a most flat focus characteristic among the phase shift masks, the amount of the spherical aberration is obtained based on the phase shift amount of the specified one of the phase shift masks.

It is to be noted, however, that the absolute value of the spherical aberration does not necessarily correspond in one-to-one correspondence to the best focus shift amount of a single pattern or the difference in the best focus shift amount between the different patterns.

In general, aberrations are totally discussed in connection with terms of the polynomial defined by Zernike, wherein the components of the spherical aberration correspond to third-order (Z13), fifth-order (Z25), seventh-order (Z41) etc. terms of the Zernike polynomial. The number of the order corresponds to the number of inflection in the graph of the component of the spherical aberration in the Zenrike polynomial.

Referring to FIGS. 2 and 3, there are shown differences (μm) in the best focus shift amount between two half-tone phase shift mask patterns having different pattern sizes and the best focus shift amount of an isolated pattern in a half-tone phase shift mask, respectively, plotted against values of the respective-order components of the spherical aberration.

In FIG. 2, the focus differences (μm) in the best focus shift amount between a pair of phase shift masks is plotted against the matrix of respective-order components of the spherical aberration. The focus differences were obtained from the half-tone phase shift masks having a half-tone transmittance (HT transmittance) of 6% and including square hole patterns having pattern sizes of 130 nm and 300 nm. These phase shift masks were exposed under the conditions where the wavelength (λ) of the exposure light from ArF, numerical aperture (NA) and the coherent factor (σ) are 193 nm, 0.75 and 0.3, respectively.

The matrix below the abscissa includes a first row of third-order components (Z13) of the spherical aberration, a second row of fifth-order components (Z25), and a third row of seventh-order components (Z41), which are normalized with a unit of λ. Since the spherical aberrations of the practical exposure systems for semiconductor devices reside within ±0.02λ in general, three values of the spherical aberration including +0.02λ, 0 and −0.02λ are sufficient for a qualitative discussion of the spherical aberration of the projection lens.

Thus, for the graph of FIG. 2 as well as FIG. 3, a total of nine levels of the spherical aberration were examined including the three values of the fifth-order component with the three values of the seventh-order component for the single value of the third-order component which is selected at +0.02λ. These values arranged along the abscissa show the examined levels, whereas the value plotted on the ordinate of FIG. 2 is the focus difference in the best focus shift amount measured for each of the respective levels.

In FIG. 3, the best focus shift amounts were measured for a single half-tone phase shift mask having therein an isolated pattern and having a HT transmittance of 6%. The conditions of the exposure not specified here are similar to those used in FIG. 2. As in the case of FIG. 2, a total of nine levels are examined including three cases of fifth-order spherical aberration with three cases of seventh-order spherical aberration for the third-order spherical aberration of +0.02λ.

Both the figures show that a smaller spherical aberration does not necessarily correspond to the best focus shift amount or the difference in the best focus shift amount, and vice versa. Thus, the spherical aberration cannot be reduced merely by reducing the best focus shift amount of a pattern or the difference in the best focus shift amount between two different patterns.

In addition, if a half-tone phase shift mask is employed for exposure and the optical phase of the diffracted lights are changed on the mask surface, the best focus shift amount appears further greater.

The technique described in JP-A-2000-266640 raises the cost for the exposure due to using a pair of phase shift masks having different two-dimensional patterns. On the other hand, the technique described in JP-B-3080024 requests drastic reductions in the respective-order components of the spherical aberrations because the variance of the dimensions of the isolated pattern follows the root-mean-square of the respective-order components.

Especially in the on-body exposure system, it is only the lower-order component of the spherical aberration that can be intentionally corrected, and for this purpose it is desired to measure the lower-order component with a higher accuracy for correction of the spherical aberration. However, the higher-order components are in fact also corrected undesirably together with the lower-order component. This leads to the fact that correction of the spherical aberration based on the focus difference between the different pattern sizes or the best focus shift amount of the isolated hole pattern does not necessarily suppress the variance of dimensions of the isolated pattern.

More specifically, although the focus difference between the best focus shift amounts of a larger pattern and a smaller pattern is used in the conventional technique for correcting the spherical aberration, the value obtained by the measurement is the index and not the spherical aberration itself because the spherical pattern in fact includes a variety of terms determined by the number of the points of inflection that the wave aberration has on the pupil surface of the projection lens.

Thus, the spherical aberration cannot be correctly reduced if the lower-order component which can be intentionally corrected is not measured separately from the higher-order components in the spherical aberration. In this respect, the condition that allows the flatness factor to be reduced to zero in JP-A-2000-266604 is considered no more than the index used in the conventional technique in view that the terms are not separated in the polynomial in the described technique.

In addition, the conventional techniques including the technique described in JP-A-2000-266604 use a mask pattern having a size larger than the wavelength of the exposure light in the measurement of the spherical aberration. However, since the allowable margin for the focus of the large pattern is wide, it is extremely difficult to obtain an accurate value for the best focus shift amount.

Accordingly, a new method for measuring the spherical aberration is desired to obtain an accurate best focus shift amount by using a single fine pattern not by using a plurality of patterns having different sizes.

### SUMMARY OF THE INVENTION

In view of the above, it is an object of the present invention to provide a method for measuring the amount of the spherical aberration of a projection lens by using a single fine pattern to thereby correct the spherical aberration in an exposure system for use in fabrication of semiconductor devices.

The present invention provides a method for measuring the amount of spherical aberration of a projection lens including the steps of: exposing a half-tone phase shift mask to an exposure light having a wavelength (λ) and a coherence factor (σ); measuring a best focus shift amount of the projection lens having a numerical aperture (NA) by using the exposure light passed by the half-tone phase shift mask; and correcting the spherical aberration of the projection lens based on the best focus shift amount measured, the half-tone phase shift mask having therein a plurality of hole patterns arranged in a matrix at a pitch (P) and each having a pattern size (M), given P and M satisfying the following relationships:

0.8λ/(2×NA)≦M≦1.2λ/(2×NA);

{λ/(P×NA)}+σ≦1; and

{2×λ/(P×NA)}−σ≧1.

In accordance with the method of the present invention, the half-tone phase shift mask defined in the present invention allows the best focus shift amount of the projection lens, and thus the third-order component of the spherical aberration, to be measured accurately. Since the spherical aberration of the projection lens which is capable of being corrected in the on-body exposure system is the lower-order component, or third-order component, of the spherical aberration, the accurate measurement of the third-order component of the spherical aberration allows an accurate correction of the spherical aberration of the lens system.

The above and other objects, features and advantages of the present invention will be more apparent from the following description, referring to the accompanying drawings.

### BRIEF DESCRIPTION OF THE DRAWINGS

FIG. 1 is a schematic explanatory view for showing occurrence of the spherical aberration in an exposure system.

FIG. 2 is graph showing the relationship between the components of the spherical aberration and the difference in the best focus shift amount between two patterns.

FIG. 3 is a graph showing the relationship between the components of the spherical aberration and the best focus shift amount of a single pattern.

FIG. 4A is a schematic explanatory view showing an example of the actual spherical aberration.

FIG. 4B is a graph showing respective-order components included in the spherical aberration shown in FIG. 4A.

FIG. 5 is a sectional view of a half-tone phase shift mask, illustrating the relationships among the diffraction angle, wavelength of the exposure light and the pitch of the patterns on the half-tone phase shift mask.

FIG. 6 is a schematic top plan view of the pupil surface of a projection lens, showing the positions at which the zeroth-order and first-order diffracted light pass the pupil surface for the case of zero coherence factor.

FIG. 7 is a schematic top plan view similar to FIG. 6 for the case of non-zero coherence factor.

FIG. 8 is a top plan view of a half-tone phase shift mask used in a method according to an embodiment of the present invention.

FIG. 9 is graph showing the relationship between the components of the spherical aberration and the best focus shift amount obtained by the method of the present embodiment.

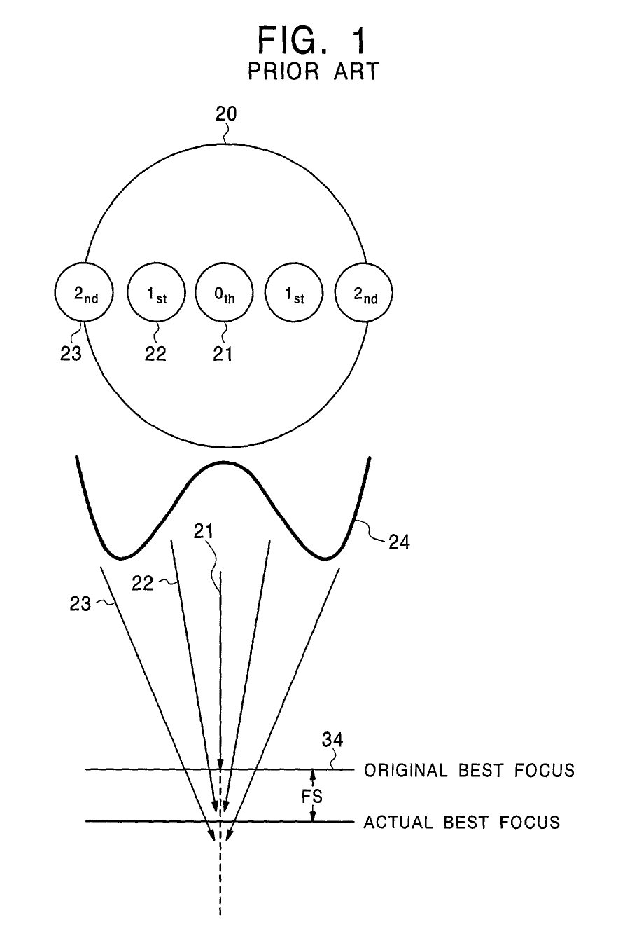

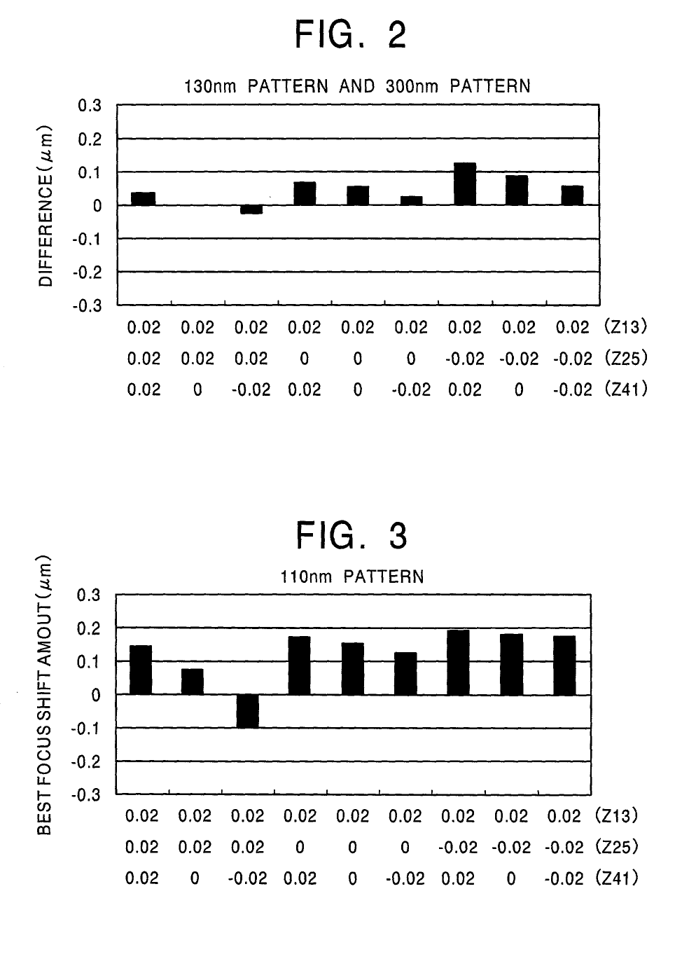

### PREFERRED EMBODIMENT OF THE INVENTION

Before describing the preferred embodiment of the present invention, the principle of the present invention will be described for a better understanding of the present invention.

The present inventor found the following facts in the procedure for solving the above problem of the conventional techniques for measuring the spherical aberration.

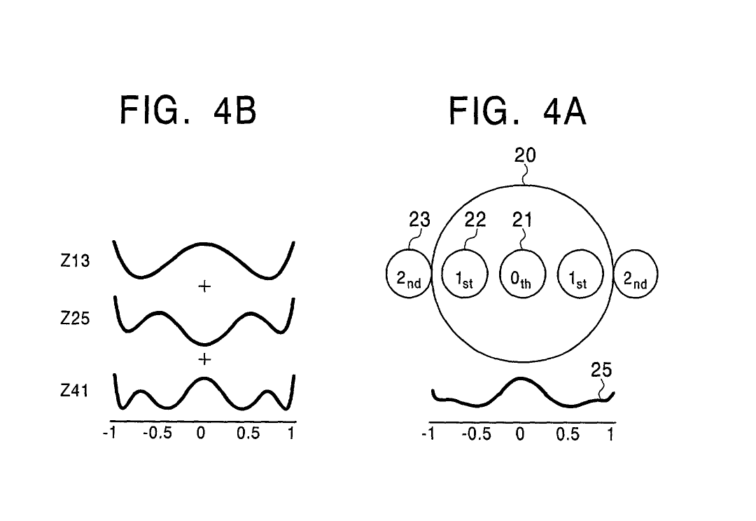

FIG. 4A includes a schematic top plan view of respective components 21, 22 and 23 of a diffracted light on a pupil surface of a projection lens 20, and a graph 25 of an example of the spherical aberration, which may be observed for the diffracted light shown and is plotted on the ordinate against the coordinate of the pupil surface 20 normalized with the numerical aperture and plotted on abscissa. FIG. 4B is a graph for the respective components of the spherical aberration depicted in FIG. 4A, showing the contribution of the respective components to the total spherical aberration.

As described before, the components of the spherical aberration correspond to the third-order (Z13), fifth-order (Z25) and seventh-order (Z41) terms in the Zernike polynomial. However, as understood form FIG. 4A, the condition wherein the best focus shift amount is most affected by the spherical aberration corresponds only to zeroth-order component and the first-order (primary) component of the diffracted light, which actually pass the projection lens 20 and form a focus. In addition, the first-order component of the diffracted light contributes only in the case that the first-order component passes the projection lens 20 at the edge thereof, i.e., at the position where the coordinate of the pupil surface is 1.

Especially, if the coherence factor of the exposure light is around 0.3 and the higher-order components of the spherical aberration are not high, it is considered that the influence by the fifth-order component and higher-order components of the spherical aberration are cancelled by each other. This is confirmed by FIG. 4B, wherein the best focus shift amount substantially depends only on the third-order component (Z13) of the spherical aberration and thus not affected by the fifth-order and seventh-order components (Z25 and Z41) of the spherical aberration. That is, the best focus shift amount is substantially determined only by the third-order component (Z13) of the spherical aberration.

It was confirmed, by analyzing the configuration of phase shift masks, that an accurate best focus shift amount corresponding to the third-order component of the spherical aberration which is most suitable for correcting the spherical aberration of a projection lens can be obtained by using a specific half-tone phase shift mask in an exposure.

The specific half-tone phase shift mask includes a plurality of square hole patterns each having a mask size “M” at each side of the square and arranged in a matrix at a pitch “P”, given M and P satisfying the following relationships:

0.8λ/(2×NA)≦M≦1.2λ/(2×NA) (1);

{λ/(P×NA)}+σ≦1; (2) and

{2×λ/(P×NA)}−σ≧1 (3),

wherein λ, NA, a are wavelength of the exposure light, numerical aperture of the projection lens and the coherence factor of the exposure light, respectively. It is preferable that the coherent factor σ be equal to or above 0.1 in view of the practical process, and the coherent factor σ should be equal to or below 0.33 due to the condition that the pitch P satisfying the above relationships exists.

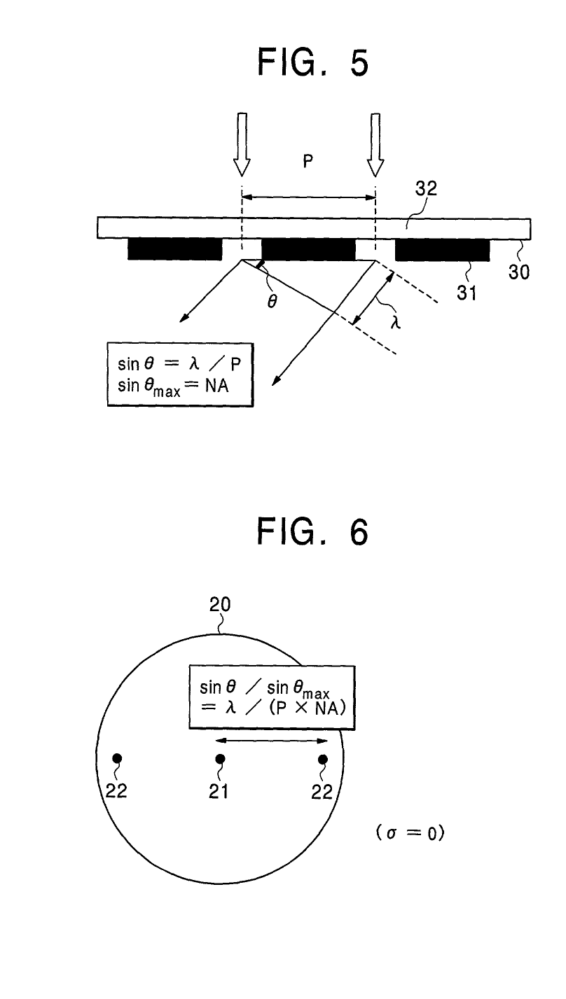

FIG. 5 shows the typical relationship among the diffraction angle of a half-tone phase shift mask, wavelength of an exposure light and the numerical aperture of a projection lens. In FIG. 5, reference numerals 30, 31 and 32 denote a transparent substrate, a half-tone phase shift film, and a hole pattern formed in the halftone shift film 31, respectively. The diffraction angle θ and the maximum diffraction angle θ max are expressed in terms of the pitch P of the arrangement of the hole patterns and the wavelength λ of the exposure light by the following formulas:

sin θ=λ/P; and

sin θmax=NA.

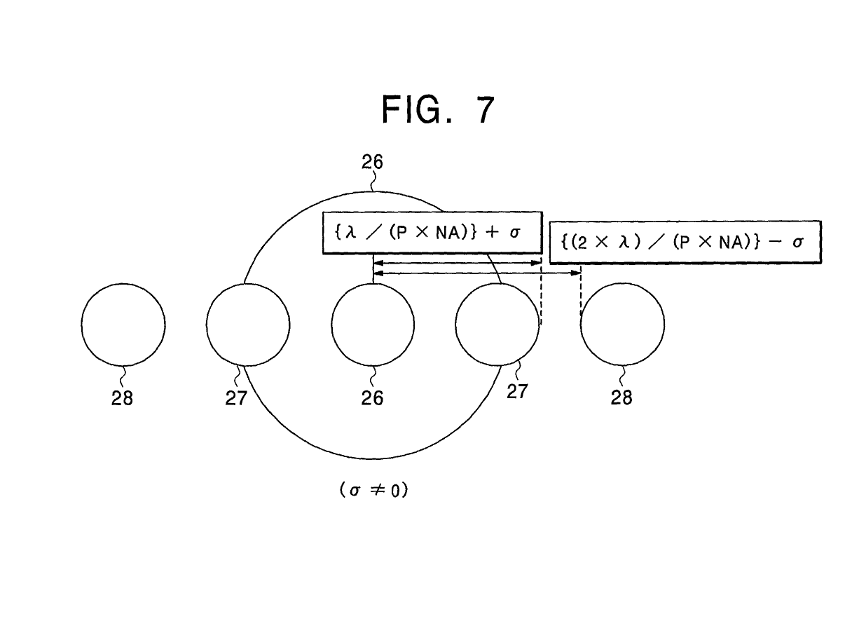

The relationships (2) and (3) are derived from the relationships among the diffraction angle (θ), the wavelength (λ) and the pitch (P) shown in FIG. 5, together with the relationship, such as shown in FIG. 6, between the positions at which the zeroth-order diffracted light beam 21 and the first-order diffracted light beam 22 pass through the projection lens 20 and the geometrical relationships, such as shown in FIG. 7, between the position at which the zeroth-order diffracted light flux 26 passes and the position at which the first-order component diffracted light flux 27 and the second-order component diffracted light flux 28 pass.

The relationship (2) corresponds to the condition where the first-order diffracted light beam is incident onto the pupil surface at 100%, as shown in FIG. 6, wherein the following relationship:

sin θ/sin θmax=λ/(P×NA)≦1,

is satisfied for the distance λ/(P×NA) between the position at which the zeroth-order diffracted light beam 21 passes and the position at which the first-order diffracted light beam 22 passes.

On the other hand, the relationship (3) corresponds to the condition where the first-order diffracted light flux 27 is incident onto the pupil surface whereas the second-order diffracted light flux 28 is not incident onto the pupil surface as shown in FIG. 7. This leads to the relationships (2):

{λ/(P×NA)}+σ≦1≦{(2×λ)/(P×NA)}−σ.

In both FIGS. 6 and 7, it is to be noted that the dimensions are normalized by the radius of the pupil surface of the projection lens 20. In addition, in FIG. 7, the diameter of each flux of the diffracted lights is equal to the coherent factor σ.

By the relationships (2) and (3), all the first-order diffracted light is incident onto the projection lens and forms the focus, whereas none of the second-order diffracted light is incident onto the projection lens.

Now, preferred embodiment of the present invention is specifically described with reference to accompanying drawings.

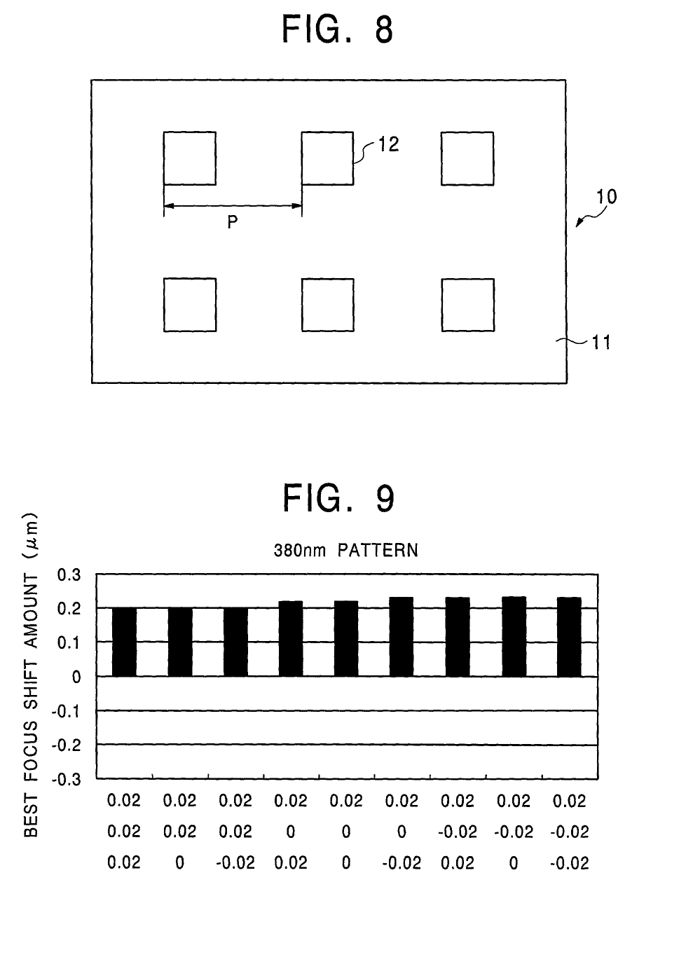

Referring to FIG. 8, a half-tone phase shift mask, generally designated by numeral 10, for use in a method according to an embodiment of the present invention includes a half-tone phase shift film 11 having therein a plurality of square hole patterns 12 arranged with a pitch P. Each square pattern 12 has a side (or mask size) of M=λ/(2×NA). The half-tone phase shift film 11 has a transmittance of around 20% and shifts the phase of the exposure light by 180 degrees. The half-tone phase shift mask 10 is irradiated by an exposure light for measuring the best focus shift amount of the projection lens in the exposure system.

The pitch P of the array of the hole patterns 12 is determined to satisfy the following relationships:

{λ/(P×NA)}+σ≦1; and

{2×λ/(P×NA)}−σ≧1,

wherein λ, NA and σ are wavelength of the exposure light, numerical aperture of the projection lens and the coherence factor of the exposure light. The coherence factor σ is 0.1 or above in the view point of practical use, and should be 0.33 or below due to the condition that the pitch P satisfying the above relationships exists.

As described before, the components of the spherical aberration correspond to third-order (Z13), fifth-order (Z25), seventh-order (Z41) etc. terms in the Zenrike polynomial. In view of this, for a third-order component of the spherical aberration at Z13=+0.02λ, the best focus shift amount obtained by the halftone phase shift mask of FIG. 8 having a pitch at P=380 nm is shown in FIG. 9, with both the fifth-order and seventh-order components being −0.02λ, 0 and +0.02λ. For determining the pitch P at 380 nm, the above relationships (2) and (3) are used with the wavelength λ, numerical aperture NA and coherence factor σ being 193 nm, 0.75 and 0.3, respectively, whereby the range of the pitch P is obtained between 368 nm and 396 nm.

In view that the practical exposure system generally has a spherical aberration within ±0.02λ, the values of the respective components shown in FIG. 9 are sufficient for qualitatively analyzing the spherical aberration. The best focus shift amounts observed for the third-order component of 0.02λ resided in the vicinity of 0.2 μm and was sensitive to the third-order component, irrespective of the values for the fifth-order and seventh-order components of the spherical aberration.

Thus, by correcting the spherical aberration of the projection lens of the exposure system based on the third-order component of the spherical aberration corresponding to the best focus shift amount measured in an exposure using the half-tone phase shift mask of FIG. 8, an accurate correction can be obtained.

It is to be noted that the method of the above embodiment does not use the difference between the best focus shift amounts of a plurality of pattern sizes. The method of the above embodiment uses the best focus shift amount measured from a single pattern size to obtain an accurate correction of the spherical aberration of the projection lens.

Since the above embodiments are described only for examples, the present invention is not limited to the above embodiments and various modifications or alterations can be easily made therefrom by those skilled in the art without departing from the scope of the present invention. For example, the hole pattern is not limited to a square pattern, and may be a rectangular or another polygon having a similar size, or substantially inscribed with a circle which circumscribes the square pattern having the pattern size M.

What is claimed is:

1. A method for correcting a spherical aberration in an exposure system comprising the steps of:
exposing a half-tone phase shift mask to an exposure light having a wavelength (λ) and a coherence factor (σ);
measuring a best focus shift amount of the projection lens having a numerical aperture (NA) by using the exposure light passed by the half-tone phase shift mask; and
correcting the spherical aberration of the projection lens based on the best focus shift amount measured,
the half-tone phase shift mask having therein a plurality of hole patterns arranged in a matrix at a pitch (P) and each having a pattern size (M), given P and M satisfying the following relationships:
0.8λ/(2×NA)≦M≦1.2λ/(2×NA);
{λ/(P×NA)}+σ≦1; and
{2×λ/(P×NA)}−σ≧1.

2. The method as defined in claim 1, wherein the coherence factor (σ) is between 0.1 and 0.33.

3. The method as defined in claim 1, wherein each of the hole patterns is a polygon.

4. The method as defined in claim 1, wherein each of the hole patterns is square.
